(19) United States
(12) Patent Application Publication
(10) Pub. No.: US 2008/0190841 A1
(43) Pub. Date: Aug. 14, 2008

(54) CERAMIC MEMBRANES WITH IMPROVED ADHESION TO PLASMA-TREATED POLYMERIC SUPPORTING MATERIAL AND THEIR PRODUCTION AND USE

(75) Inventors: Matthias Pascaly, Muenster (DE); Rolf-Walter Terwonne, Marl (DE); Christian Hying, Rhede (DE); Gerhard Hoerpel, Nottuln (DE)

Correspondence Address: OBLON, SPIVAK, MCCLELLAND MAIER & NEUSTADT, P.C., 1940 DUKE STREET, ALEXANDRIA, VA, 22314, US

(73) Assignee: EVONIK DEGUSSA GmbH, Essen (DE)

(21) Appl. No.: 12/021,436

(22) Filed: Jan. 29, 2008

(30) Foreign Application Priority Data
Jan. 29, 2007 (DE) 102007005156.7

(51) Int. Cl. B01D 53/22; B01D 67/00; H01M 2/16; B60K 1/04; B01D 71/02

(52) U.S. Cl. 210/500.25; 264/430; 264/483; 429/247; 180/65.1

(57) ABSTRACT

A flexible, ceramic membrane is useful as a separator for batteries, especially lithium batteries, the membrane containing a polymeric non-woven; a ceramic coating on and in the non-woven; wherein the ceramic coating comprises at least one oxide selected from the group consisting of Al₂O₃, TiO₂, ZrO₂, BaTiO₃, SiO₂, and mixtures thereof; wherein the coating comprises at least two fractions of oxides selected from the group consisting of Al₂O₃, TiO₂, ZrO₂, BaTiO₃, SiO₂, and mixtures thereof; a first ceramic fraction of the coating having been obtained from a sol; a second fraction of the coating comprising particles having an average particle size in the range from 200 nm to 5 μm; wherein the first fraction is present as a layer on the particles of the second fraction; the coating comprising from 0.1 to 50 parts by mass of the first fraction; the coating comprising from 5 to 99 parts by mass of the second fraction; and a network comprising silicon or zirconium; wherein the silicon in the network bonds via oxygen atoms to the oxides of the ceramic coating, via organic radicals to the surface of the polymeric non-woven and via at least one carbon chain to a further silicon; and wherein the coating is pinhole free.

### BACKGROUND OF THE INVENTION

1. Field of the Invention

The present invention relates to a ceramic, flexible membrane with excellent adhesion of the ceramic to the polymeric non-woven, its' production and use as a separator or as a filtering membrane in liquid filtration applications.

2. Discussion of the Background

An electrical separator is a membrane which is used in batteries and other arrangements in which electrodes have to be separated from each other while maintaining ion conductivity for example.

A separator is customarily a thin porous electro-insulating material possessing high ion perviousness, good mechanical strength and long-term stability to the chemicals and solvents used in the system, for example in the electrolyte of a battery. In batteries, a separator should fully electronically insulate the cathode from the anode but be pervious to the electrolyte. Moreover, a separator has to be permanently elastic and be capable of following the movements in the system, for example in the electrode pack in the course of charging and discharging.

The separator is a crucial determinant of the use life of the arrangement in which it is used, for example the use life of battery cells. The development of rechargeable batteries is therefore crucially dependent on the development of suitable separator materials.

General information about electrical separators and batteries may be gleaned for example from J. O. Besenhard in “Handbook of Battery Materials” (VCH-Verlag, Weinheim 1999).

Separators in use at present consist predominantly of porous organic polymeric films or of inorganic non-wovens such as for example non-wovens formed from glass or ceramic materials or else ceramic papers. These are manufactured by various companies. Important producers include Celgard, Tonen, Ube, Asahi, Binzer, Mitsubishi, Daramic and others. A typical organic separator consists for example of polypropylene or of a polypropylene-polyethylene-polypropylene composite.

Lithium batteries, which are widely used at the present time, are notable for many advantages, for example high specific energy density, no self-discharging and no memory effect, over systems having aqueous electrolytes, such as for example NiCd batteries or nickel metal hydride batteries. But lithium batteries have the disadvantage that they contain a combustible electrolyte which, moreover, can enter a very vigorous reaction with water. For high energy batteries, i.e., batteries containing a lot of active material, it is therefore very important that the electric circuit in the battery be interrupted in the event of an accident and an attendant heating-up of the cell. The interruption is customarily brought about by specific separators which consist of a composite comprising polypropylene(PP)-polyethylene(PE)-PP. At a certain temperature, the shutdown temperature, the PE will melt and the pores of the separator become closed, interrupting the electric circuit.

A disadvantage of these separators is their limited thermal stability, since the polypropylene will also melt as the cell continues to heat up, so that the entire separator will melt at this meltdown temperature and thus will allow internal short circuiting over a large area, which will frequently destroy the battery cell by fire or even explosion. True, there are now ceramic separators, for example ceramic papers or ceramic wovens or non-wovens, that do not exhibit the meltdown effect, but they unfortunately do not exhibit a shutdown effect either and that is indispensable for high energy applications in particular and is demanded by battery manufacturers.

Ceramic or semiceramic (hybridic) separators or ceramic membranes useful as separators are well known, for example from WO 99/15262. This reference also reveals the production of separators or membranes which are useful as separators. Preferably, however, the porous carriers used for the separators of the present invention are not electroconductive carriers such as woven metal fabrics for example, since the use of such carriers can give rise to internal shorting when the ceramic coating on the carrier is incomplete. Separators according to the present invention therefore preferably comprise carriers composed of nonelectroconductive materials.

A very recent development are hybridic separators which comprise ceramics and polymers. DE 102 08 277 discloses producing separators based on polymeric substrate materials (such as polymeric non-wovens for example) which have a porous electroinsulating ceramic coating. On exposure to a mechanical stress of the kind which frequently occurs in the manufacture of batteries for example, the ceramic coating will frequently become detached to some extent from these separators despite their flexibility. Batteries manufactured from these separators therefore frequently have a relatively high defect rate.

DE 103 47 569 A1 discloses ceramic, flexible membranes with improved adhesion of the ceramic to the non-woven base, their production and their use as a separator or as a filtering membrane in liquid filtration applications. The use of at least two adhesion promoters engenders a silicon-containing network, the silicon atoms in the network being bonded by oxygen atoms to one another and also to the oxides of the ceramic coating, via few reactive ends of the polymeric chains to the polymeric non-woven or via a carbon chain to a further silicon. The chains between the silicon atoms mean that there is not only an inorganic network, engendered via silicon or metal oxide bridges, but also a second, organic network which is crosslinked with the inorganic network. The organic network forms above and below the non-woven base and also through the non-woven base. Although the membrane obtained has a ceramic coating which is stable to water in particular, this coating may occasionally also exhibit cracks or else abrasion (caused by further processing, for example) which put a limit on sustained use in high energy batteries.

### SUMMARY OF THE INVENTION

It is an object of the present invention to provide membranes useful as a separator which overcome one or more disadvantages of the background art.

This and other objects have been achieved by the present invention the first embodiment of which includes a membrane, comprising:

a polymeric non-woven;

a ceramic coating on and in the non-woven;
wherein said ceramic coating comprises at least one oxide selected from the group consisting of Al₂O₃, TiO₂, ZrO₂, BaTiO₃, SiO₂, and mixtures thereof;
wherein said coating comprises at least two fractions of oxides selected from the group consisting of Al₂O₃, TiO₂, ZrO₂, BaTiO₃, SiO₂, and mixtures thereof;

a first ceramic fraction of said coating having been obtained from a sol;

a second fraction of said coating comprising particles having an average particle size in the range from 200 nm to 5 μm;

wherein said first fraction is present as a layer on said particles of the second fraction;

said coating comprising from 0.1 to 50 parts by mass of the first fraction;

said coating comprising from 5 to 99 parts by mass of the second fraction; and

a network comprising silicon or zirconium; wherein the silicon in the network bonds via oxygen atoms to the oxides of the ceramic coating, via organic radicals to the surface of the polymeric non-woven and via at least one carbon chain to a further silicon; and

wherein said coating is pinhole free.

The present invention also provides a process for producing a membrane, comprising:

providing a polymeric non-woven with a ceramic coating in and on the non-woven by applying a suspension onto and into the polymeric non-woven and solidifying said suspension on and in the non-woven by heating one or more times,

wherein said suspension comprises a sol and at least one fraction of oxidic particles selected from the group consisting of oxides of the elements Al, Zr, Ti, Ba, Si and mixtures thereof;

wherein the polymeric non-woven is subjected to a plasma treatment prior to application of the suspension, and

the suspension has added to it prior to application a mixture of at least two different adhesion promoters which are each based on an alkylalkoxysilane of the general formula I

Rₓ—Si(OR)_{4-X} (I)

wherein x=1 or 2 and R=organic radical, the R radicals being the same or different,

the adhesion promoters being selected so that the at least two different adhesion promoters comprise alkyl radicals which at least each comprise a reactive group as a substituent,

the reactive group on the alkyl radical of one adhesion promoter reacting with the reactive group of the other adhesion promoter or of the plasma treated polymeric surface during the one or more heating steps to form a covalent bond, or

one or more adhesion promoters as per the formula I, which have reactive groups which are capable of reacting under the action of UV radiation to form a covalent bond,

the addition of an adhesion promoter which reacts under the action of UV radiation being followed by one or more treatments with UV radiation after the suspension has been applied to the polymeric non-woven.

The present invention provides a membrane obtained by the above process.

The present invention also provides a filtering membrane or an electrical separator, comprising: the above membrane, wherein said membrane is free of any titanium compounds when used as a separator.

Further, the present invention provides a lithium battery, comprising: the above membrane as a separator.

The present invention provides a vehicle, comprising: the above lithium battery.

Further, the present invention provides a filtration apparatus, comprising: the above membrane.

### DETAILED DESCRIPTION OF THE INVENTION

It has now been found that, surprisingly, a treatment of the polymeric non-woven with plasma, hereinafter shortened to plasma treatment, and the subsequent use of a combination of at least two different adhesion promoters based on alkyltrialkoxysilanes wherein the alkyl group of one adhesion promoter comprises a substituent capable of reacting with a substituent of the alkyl group of the other adhesion promoter to form a covalent bond in the production of the ceramic coating, provide a coating which is notable for better adhesion compared with the background art. Surprisingly, the ceramic coatings thus produced are not only very stable to the action of water, but are also pinhole free and resistant to abrasion.

The ceramic membranes based on ceramic-coated polymeric textiles do not detach the ceramic coating when exposed to severe mechanical stress.

Plasma treatment herein is to be understood as directing a beam or jet of plasma at the polymeric non-woven. The plasma is generated in a conventional manner by discharging a high frequency alternating voltage in a gas, the working gas. Portions of this plasma are blown out of the discharge system by means of a targeted gas stream, and directed through plasma nozzles (formed by a stator within which a rotor rotates at high speed) via apertures onto the surface of the material to be treated. Plasmatreat GmbH, Bisamweg 10, D-33803 Steinhagen is named as one example of a manufacturer of plasma-generating systems for plasma-treating surfaces.

A pinhole-free and abrasion-resistant ceramic coating herein is a ceramic coating which, in a scanning electron micrograph of the surface of this coating recorded at a magnification of 10 000, has not more than 10 cracks per cm² of surface area on the coating, the number of cracks being the average value obtained from examining 10 different places on the surface. For a crack to be counted as exactly one crack it has to be detectable in the scanning electron micrograph by the naked eye and has to extend in a notional, continuous line from a starting point (which can be a point of contact with another crack) to an end point (which can likewise be a point of contact with another crack), with no further points of contact with other cracks between the starting point and the end point.

Pinholes can also be the result of wetting defects. Wetting defects are regions in the ceramic coating which, because of poor compatibility between the ceramic slip and the polymeric non-woven, form pits. Pits are circular depressions or hollows with minimally raised rims.

The present invention accordingly provides a membrane based on a polymeric non-woven, the non-woven comprising on and in the non-woven a ceramic coating comprising at least one oxide selected from Al₂O₃, TiO₂, ZrO₂, BaTiO₃ and/or SiO₂, which is characterized in that this one coating comprises at least two fractions of oxides selected from Al₂O₃, ZrO₂, TiO₂, BaTiO₃ and/or SiO₂, the first ceramic fraction having been obtained from a sol and the second fraction comprising particles having an average particle size in the range from 200 nm to 5 μm and the first fraction being present as a layer on the particles of the second fraction and the first fraction comprising from 0.1 to 50 parts by mass of the coating, the second fraction comprising from 5 to 99 parts by mass of the ceramic coating and also a network comprising silicon or zirconium, the silicon in the network being bonded by oxygen atoms to the oxides of the ceramic coating, via organic radicals to the surface of the polymeric non-woven and via at least one carbon chain to a further silicon, and this coating is pinhole free.

The average particle size is based on the volume average. The volume average particle size is generally measured using a Malvern Mastersizer 2000, (measuring module: Hydro 2000S); program: Malvern Mastersizer 2000 Version 5.12G; Settings: Analyte: Al₂O₃, solvent: ethanol; range: 0.02 μm to 2000 μm.

The present invention likewise provides a process for producing a membrane, in particular a membrane which is in accordance with the present invention, comprising providing a polymeric non-woven with a ceramic coating in and on the non-woven by a suspension being applied onto and into the polymeric non-woven and being solidified on and in the non-woven by heating one or more times, the suspension comprising a sol and at least one fraction of oxidic particles selected from the oxides of the elements Al, Zr, Ti, Ba and/or Si, which is characterized in that the polymeric non-woven is subjected to a plasma treatment prior to application, and the suspension has added to it prior to application a mixture of at least two different adhesion promoters which are each based on an alkylalkoxysilane of the general formula I

Rₓ—Si(OR)₄₋ₓ (I)

where x=1 or 2 and R=organic radical, the R radicals being the same or different,

the adhesion promoters being selected so that both the adhesion promoters comprise alkyl radicals which at least each comprise a reactive group as a substituent, the reactive group on the alkyl radical of one adhesion promoter reacting with the reactive group of the other adhesion promoter or of the plasma treated polymeric surface during the one or more heating steps to form a covalent bond, or one or more adhesion promoters as per the formula I, which have reactive groups which are capable of reacting under the action of UV radiation to form a covalent bond, the addition of an adhesion promoter which reacts under the action of UV radiation being followed by one or more treatments with UV radiation after the suspension has been applied to the polymeric non woven.

The present invention also provides for the use of present membranes or separators as an electrical separator and also the batteries themselves which comprise such present membrane as a separator.

One advantage of the present membrane is that the ceramic coating is pinhole free. The present membrane is thus produced with an exactly defined pore size distribution. But the avoidance of pinholes does not impair the penetration of the membrane by electrolytes and their ion conductivity. On the contrary, only advantages result. For instance, batteries containing the present separator are free of microshorts (shorts which although permitting the battery to operate lead to its gradual self-discharge). This also leads to an improvement in battery safety, since the weak point of a thin separator layer which leads to shorts in the background art is eliminated by the present membrane. Similarly, the present membrane has the advantage that one and the same battery volume can accommodate more windings of electrodes and separators or higher pack density of electrodes and separator, making batteries possible with an increased capacity compared with the background art.

The membrane of the present invention has the further advantage of significantly higher stability in water and polar organic solvents than membranes produced using just one or more adhesion promoters and without pretreatment of the polymeric substrate, which do not have good wetting of the polymeric non-woven and in which no covalent bonds form between the adhesion promoters and the surface of the polymeric non-woven. Owing to its higher stability to mechanical stress as well as water and polar organic solvents, the membrane provides significantly improved processibility at the stage of battery building and an improvement in battery performance.

The membrane of the present invention also has the advantage that the ceramic coating has an improved DIN 58 196-6 adhesion to the polymeric non-woven compared with the background art.

The production of the membrane according to the present invention by using specific adhesion promoters has advantageous repercussions for the process as well. For instance, the solidifying of the coating in the process of the present invention can take place at relatively low temperatures (drying or solidification temperature), which is why it has even become possible to produce membranes having a durable ceramic coating which are based on a polymeric substrate which have a melting or softening point of at least 120 to 150° C., such as for example polyamide, polypropylene or polyethylene.

A membrane produced as described in a specific embodiment to comprise at least two fractions of metal oxides further has the advantage of being indestructible by bending, folding or crumpling once the ceramic coating has solidified on the non-woven. The membrane is thus bendable virtually down to a bending radius of 0 mm. As a result, the membranes of the present invention have dramatically superior mechanical stability than background art ceramic or hybridic membranes. This decisively improves the ease of handling this membrane in the course of its production but also in the course of its processing, i.e., the production of, for example, wound or stacked batteries. Batteries produced using the membranes of the present invention as separators comprise a very low defect rate.

The membranes of the present invention which are to be used as separators comprise a plasma treated polymeric non-woven having a porous inorganic non-electroconductive coating on and in this non-woven, and have the advantage of possessing excellent safety properties. A meltdown cannot happen with the separator of the present invention, since the inorganic layer prevents large-area shorting within the battery even at comparatively high temperatures. The absence of pinholes makes possible a narrower pore size distribution for the membrane compared with the background art. The fact that there are no pinholes, i.e., no undesirably large pores, also reduces the likelihood of shorts and also microshorts. This improves battery safety as well as reducing the self-discharge rate.

The separator according to the present invention is also very safe in the event of internal short circuiting due to an accident for example. If, for example, a nail were to puncture the battery, the following would happen depending on the type of separator: a polymeric separator would melt at the site of puncture (a short circuiting current would flow through the nail and cause it to heat up) and contract. As a result, the short circuiting location would become larger and larger and the reaction would get out of control. With the separator according to the present invention, however, the polymeric non-woven would melt, but not the inorganic separator material. Thus, the reaction in the interior of the battery cell would proceed much more moderately after such an accident. This battery would thus be distinctly safer than one with a polymeric separator. This is an important factor in mobile applications in particular.

The advantages of the membrane of the present invention when used as a separator in lithium ion batteries can be summarized as follows:

High porosity

Ideal pore size

Low thickness

Low basis weight

Very good wettability

High safety, i.e., no meltdown effect

Improved DIN 58 196-6 adhesion

Very good foldability/bendability, which is why they are particularly good for use in very narrowly wound lithium batteries, especially crashed cells.

Absence of pinholes and wetting defects.

The membrane of the present invention and a process for producing it will now be described without the invention intending to be limited to these embodiments.

The present invention's membrane based on a polymeric non-woven, the non-woven comprising on and in the non-woven at least one ceramic coating comprising at least one oxide selected from Al₂O₃, TiO₂, ZrO₂, BaTiO₃ and/or SiO₂, is characterized in that this one coating comprises at least two fractions of oxides selected from Al₂O₃, ZrO₂, TiO₂, BaTiO₃ and/or SiO₂, the first ceramic fraction having been obtained from a sol and the second fraction comprising particles having an average particle size in the range from 200 nm to 5 μm and the first fraction being present as a layer on the particles of the second fraction and the first fraction comprising from 0.1 to 50 parts by mass of the coating, the second fraction comprising from 5 to 99 parts by mass of the ceramic coating and also a network comprising silicon or zirconium, the silicon in the network being bonded by oxygen atoms to the oxides of the ceramic coating, via organic radicals to the plasma treated surface of the polymeric non-woven and via at least one carbon chain to a further silicon, and this coating is pinhole free.

The particle size of the particles of the second fraction includes all values and subvalues therebetween, especially including 0.3, 0.4, 0.5, 1, 1.5, 2, 2.5, 3, 3.5, 4 and 4.5 μm. The amount of the first fraction includes all values and subvalues therebetween, especially including 0.5, 1, 5, 10, 15, 20, 25, 30, 35, 40 and 45 parts by mass based on the mass of the coating. The amount of the second fraction includes all values and subvalues therebetween, especially including 10, 15, 20, 25, 30, 35, 40, 45, 50, 55, 60, 65, 70, 75, 80, 85, 90 and 95 parts by mass based on the mass of the coating.

The sol comprising silanes is able to form covalent bonds with the plasma treated surface of the polymeric non-woven.

It can be advantageous when the chain comprising carbon atoms also comprises a nitrogen atom. It can further be advantageous when the chain comprising carbon atoms also comprises a nitrogen atom when using suitable silane-containing adhesion promoters such as AMEO for example. Preferably, the present invention's membrane comprises a silicon network wherein the chains by which the silicon atoms are connected to each other by carbon atoms, through silicon atoms connected by chains comprising nitrogen, was obtained by addition of an amino group onto a glycidyl group. Owing to these chains between the silicon atoms, there is not only an inorganic network formed via Si— or metal-oxygen bridges but also a second, organic network which is reticulated with the first, inorganic network. This and the covalent bonding of the silicon atoms to the plasma treated surface of the polymeric non-woven significantly augment the stability of the membrane, especially against water and other polar solvents. When the membrane of the present invention is to be used as a separator, the membrane is free of any titanium compounds (TiO₂) but comprises, especially as particles or as a sol, only SiO₂, Al₂O₃, BaTiO₃ and/or ZrO₂.

Depending on the embodiment of the membrane of the present invention, it can comprise particles as a first ceramic fraction, especially particles having an average particle size of less than 20 nm. Such a ceramic fraction can have been produced via a particulate sol for example. In another preferred embodiment of the membrane according to the present invention, the ceramic fraction contains particles or a polymer-like inorganic network which were produced via a polymeric sol. The ceramic fraction has a layer thickness on the surface of the particles of the second fraction which is preferably less than 100 nm and more preferably less than 50 nm. The second fraction of particles preferably has a BET surface area of less than 5 m²/g.

The membranes of the present invention preferably comprise polymeric non-wovens which are flexible and preferably less than 50 μm in thickness and less than 25 g/m² in basis weight. The flexibility of the non-woven ensures that the membrane of the present invention can be flexible as well.

The high flexibility of the membranes according to the invention, then, also makes it possible to use these as separators in wound cells which have a small winding radius of less than 0.5 mm.

The thickness of the non-woven has a significant bearing on the properties of the membrane, especially on the properties of a membrane used as a separator, since not only the flexibility but also the sheet resistance of the electrolyte-saturated separator is dependent on the thickness of the non-woven. The membrane of the present invention therefore preferably comprises non-wovens which are less than 30 μm and especially from 10 to 20 μm in thickness. The thickness includes all values and subvalues therebetween, especially including 0.5, 1, 5, 10, 15, 20 and 25 μm. The membrane of the present invention more preferably comprises non-wovens having a basis weight of less than 20 g/m and especially in the range from 5 to 15 g/m². To be able to achieve sufficiently high battery performance, especially in the case of lithium ion batteries, it has been determined to be advantageous for the membrane of the present invention to comprise a carrier whose porosity is preferably above 50%, more preferably in the range from 50% to 97%, even more preferably in the range from 60% to 90% and most preferably in the range from 70% to 90%. Porosity in this context is defined as the volume of the non-woven (100%) minus the volume of the fibers of the non-woven, i.e., the fraction of the volume of the non-woven that is not taken up by material. The volume of the non-woven can be calculated from the dimensions of the non-woven. The volume of the fibers is calculated from the measured weight of the non-woven in question and the density of the polymeric fibers. A very homogeneous pore radius distribution in the non-woven can be important for the use in a membrane, especially separator. A very homogeneous pore radius distribution in the non-woven can, in conjunction with optimally adapted oxide particles of a certain size, lead to an optimized porosity for the membrane of the present invention, especially with regard to use as a separator. Preferably, the membrane, especially for membranes to be used as a separator, therefore comprises a non-woven which has a pore radius distribution where at least 50% of the pores have a pore radius in the range from 100 to 500 μm. The pore radius includes all values and subvalues therebetween, especially including 150, 200, 250, 300, 350, 400 and 450 μm.

The polymeric fibers of the non-woven preferably comprise non-electroconductive fibers of polymers which are preferably selected from polyacrylonitrile (PAN), polyester, for example polyethylene terephthalate (PET), polyamide (PA), for example nylon 12 or polyolefins, for example polypropylene (PP) or polyethylene (PE). More preferably, the non-woven comprises polymeric fibers composed of polyester, especially PET, and/or polyamide, especially nylon 12, or consists fully of these polymeric fibers. The polymeric fibers of the non-wovens are preferably from 0.1 to 10 μm and more preferably from 1 to 5 μm in diameter.

In a preferred embodiment of the membrane according to the present invention, the coating comprises at least three fractions of oxides selected from Al₂O₃, ZrO₂, TiO₂, BaTiO₃ and/or SiO₂, the first fraction being present as a layer on the particles of the second fraction and the first fraction comprising from 10 to 80 parts by mass of the coating and the second fraction comprising from 20 to 90 parts by mass of the ceramic coating.

In this preferred embodiment, the large particles (second fraction) serve as a filling material for the large meshes in the carrier. The first ceramic fraction serves as an inorganic binder which fixes the particles to each other and also to the surface-treated non-woven (or to the inorganic silicon network formed by the adhesion promoters), covalently if desired. The inorganic network and the plasma treatment of the non-woven ensure particularly good adhesion of the ceramic coating to the polymeric non-woven along with good flexibility.

The membrane of the present invention more preferably comprises a coating where the second fraction comprises particles having an average particle size in the range from 0.2 to 5 μm and the first fraction comprises from 10 to 80 parts by mass of the coating and the second fraction comprises from 20 to 90 parts by mass of the ceramic coating. Preference is given to using aluminum oxide and/or SiO₂ particles which are crosslinked by silicon dioxide particles. The particles (for example Sipemat, Aerosil or VP Zirkoniumoxid, all Degussa AG and also the aluminas CT800SG, AlCoA, and MZS Martinswerke) are commercially available. The first ceramic SiO₂-containing fraction comes from sols, which are likewise commercially available or have to be self-produced.

The membranes of the present invention are bendable without damage preferably down to any radius down to 50 m, preferably 10 cm and more preferably 5 mm without defects arising in the coating as a result. The membranes of the present invention are also notable for a breaking strength of at least 1 N/cm, preferably of at least 3 N/cm and most preferably of above 6 N/cm.

The membranes of the present invention have, in a scanning electron micrograph of the surface of their ceramic coating recorded at a magnification of 10 000, preferably not more than 5 cracks per cm² of surface area on the coating, more preferably not more than 2 cracks per cm² and most preferably not more than 1 crack per cm², the number of cracks being the average value obtained from examining 10 different places on the surface.

Membranes according to the present invention which comprise the abovementioned fractions in the specified mass ranges may be even more flexible. These membranes are bendable without damage preferably down to any radius down to 100 m, preferably down to a radius in the range from 100 m to 5 mm, more preferably down to a radius in the range from 5 to 0.5 mm, more preferably down to 0.1 mm and most preferably down to 0.01 mm without defects arising as a result. More particularly, the membranes of the present invention can be folded in the same way as, for example, cloths without the ceramic coating becoming detached. The high breaking strength and the good bendability of the membrane according to the present invention has the advantage that, when the membrane is used as a separator, the separator is able to keep up with electrode geometry changes occurring in the course of the charging and discharging of the battery without the separator becoming damaged. The bendability, moreover, has the advantage that commercially standardized wound cells can be manufactured using this separator. With these cells, the electrode-separator plies are spirally wound up with each other in standardized size and contacted.

A membrane according to the present invention which is to be used as a separator may preferably have a porosity in the range from 30% to 80%. Porosity here refers to the accessible, i.e., open, pores. Porosity in this sense can be determined by the familiar method of mercury porosimetry or can be calculated from the volume and the density of the ingredients used on the assumption that open pores only are present. By average pore size and the porosity are meant the average pore size and the porosity as may be determined by the known method of mercury porosimetry using for example a 4000 Porosimeter from Carlo Erba Instruments. Mercury porosimetry is based on the Washburn equation (E. W. Washburn, “Note on a Method of Determining the Distribution of Pore Sizes in a Porous Material”, Proc. Natl. Acad. Sci., 7, 115-116 (1921)).

When the membrane is used as a separator, it may further be advantageous for a shutdown function to be present. For this purpose, shutdown particles or a layer of shutdown particles can be present on the ceramic layer. Such shutdown particles can be for example natural or artificial waxes, (low-melting) polymers, for example polyolefins or mixtures thereof, in which case the material for the shutdown particles is chosen so that the particles will melt at a desired shutdown temperature and close the pores of the separator (membrane) to prevent any further ion flux. It is particularly preferable for the membrane for use as a separator with shutdown function to comprise shutdown particles composed of polyethylene (wax).

The size of the shutdown particles is freely choosable in principle as long as it is ensured that the pores in the inorganic layer do not become clogged during the production of the separator (membrane) of the present invention. Preferably, the shutdown particles have an average particle size (D_{w}) which is greater than the average pore size (dₛ) of the pores in the inorganic layer. More preferably, the shutdown particles have an average particle size (D_{w}) which is greater than the average pore diameter (dₛ) and less than 5 dₛ and more preferably less than 2 dₛ. This is advantageous in particular because this prevents penetration and closing of the pores in the inorganic layer that would result in a reduction in ion flow and hence in reduced separator conductivity and also reduced battery performance. The thickness of the shutdown particle layer is only critical insofar as an excessively thick layer would unnecessarily increase the resistance in the battery system. To achieve safe shutdown, the shutdown particle layer should have a thickness (z_{w}) which is approximately in the range from the average particle size of the shutdown particles (D_{w}) up to 10 D_{w} and preferably in the range from less than 2 D_{w} to more than 1 D_{w}.

The membranes/separators having a shutdown function are preferably less than 50 μm, more preferably less than 40 μm and even more preferably from 5 to 35 μm in thickness. Without shutdown particles, the separator of the present invention is preferably from 15 to 50 μm and preferably from 20 to 30 μm in thickness. Separator thickness has a large bearing on separator properties, since not only the flexibility but also the sheet resistance of the electrolyte-saturated separator is dependent on the thickness of the separator. The low thickness ensures a particularly low electrical resistance for the separator in use with an electrolyte. The separator itself does of course have a very high electrical resistance, since it itself has to have insulating properties. Moreover, thinner separators permit an increased pack density in a battery stack, so that a larger amount of energy can be stored in the same volume.

The separators of the present invention are preferably obtainable by the process of the present invention. The process for producing a membrane, in particular a membrane according to the present invention, comprises providing a process for producing a membrane comprising providing a polymeric non-woven with a ceramic coating in and on the non-woven by a suspension being applied onto and into the polymeric non-woven and being solidified on and in the non-woven by heating one or more times, the suspension comprising a sol and at least one fraction of oxidic particles selected from the oxides of the elements Al, Zr, Ti, Ba and/or Si, characterized in that the polymeric non-woven is subjected to a plasma treatment prior to application of the suspension, and the suspension has added to it prior to application a mixture of at least two different adhesion promoters which are each based on an alkylalkoxysilane of the general formula I

Rₓ—Si(OR)₄₋ₓ (I)

where x=1 or 2 and R=organic radical, the R radicals being the same or different,

the adhesion promoters being selected so that both the adhesion promoters comprise alkyl radicals which at least each comprise a reactive group as a substituent, the reactive group on the alkyl radical of one adhesion promoter reacting with the reactive group of the other adhesion promoter or of the plasma treated polymeric surface during the one or more heating steps to form a covalent bond, or one or more adhesion promoters as per the formula I, which have reactive groups which are capable of reacting under the action of UV radiation to form a covalent bond, the addition of an adhesion promoter which reacts under the action of UV radiation being followed by one or more treatments with UV radiation after the suspension has been applied to the polymeric non-woven.

The treatment with UV radiation can be effected for example by means of a UV lamp, in which case the amount of energy received has to be sufficient to ensure crosslinking of the adhesion promoters. An appropriate treatment can be effected for example by irradiation with a mercury vapor lamp having a wavelength of 254 nm for 0.1 to 24 hours and preferably 1 to 4 hours. The treatment with UV radiation can take place before or after the at least single heating. Preferably, the UV treatment is carried out after the suspension has been applied to the polymeric non-woven and before the single heating of the suspension to solidify the same. It is particularly preferable for the treatment with UV radiation to be carried out after a first heating of the suspension applied to the polymeric non-woven to predry the suspension and before a second heating to solidify the suspension. The pre-drying can take place for example at a temperature in the range from 50 to 90° C., preferably from 60 to 85° C. and preferably for a period in the range from 0.1 to 3 hours and preferably in the range from 0.5 to 1.5 hours.

The working gas for the present invention's plasma treatment of the polymeric non-woven may be preferably nitrogen, oxygen, air, argon, helium, carbon dioxide, carbon monoxide, ozone, silanes, alkanes, fluoroalkanes, fluoroalkenes, more preferably nitrogen, oxygen, air, argon or a mixture thereof. It is most preferable to use oxygen, argon, air or an oxygen-argon mixture.

It may be advantageous for the plasma treatment in the process of the present invention to utilize a radio frequency plasma, cyclotron resonance frequency plasma or microwave plasma, and it is particularly preferable to use a radio frequency plasma.

The plasma treatment in the process of the present invention may preferably utilize a plasma power in the range from 10 to 1000 W, more preferably in the range from 100 to 750 W and most preferably in the range from 300 to 500 W.

The plasma treatment in the process of the present invention may further utilize a gap of 0.1 to 300 mm, more preferably of 1 to 80 mm, even more preferably of 2 to 50 mm and most preferably of 5 to 20 mm between the nozzle and the polymeric non-woven.

The plasma treatment in the process of the present invention is preferably effected at a substrate speed of 60-0.002 m/min. Substrate speed in the context of the process of the present invention refers to the speed at which the surface of the polymeric non-woven to be treated is led through the volume occupied by the plasma. This speed can more preferably be chosen from 40 to 0.02 m/min, even more preferably from 30 to 0.2 m/min and most preferably from 20 to 0.1 m/min.

In the process of the present invention, the suspension has added to it prior to application a mixture of at least one adhesion promoter which is based on an alkylalkoxysilane of the general formula I

Rₓ—Si(OR)₄₋ₓ (I)

where x=1 or 2 and R=organic radical, the R radicals being the same or different, the adhesion promoters being selected so that both the adhesion promoters comprise alkyl radicals which at least each comprise a reactive group as a substituent, the reactive group on the alkyl radical of one adhesion promoter reacting with the reactive group of the other adhesion promoter or of the plasma treated functionalized polymeric surface during the one or more heating steps to form a covalent bond, or one or more adhesion promoters as per the formula I, which have reactive groups which are capable of reacting under the action of UV radiation to form a covalent bond, the addition of an adhesion promoter which reacts under the action of UV radiation being followed by one or more treatments with UV radiation after the suspension has been applied to the polymeric non-woven.

The use of at least two of the adhesion promoters mentioned is believed to lead to the formation, during the production of the membrane, of a network which comprises silicon, the silicon of the network being bonded via oxygen atoms to the oxides of the ceramic coating, via organic radicals and oxygen atoms to the polymeric non-woven and via at least one chain comprising carbon atoms to a further silicon. It is believed that the same effect is achieved through an at least single treatment with UV radiation when a UV-active adhesion promoter is added to the suspension. Owing to the chains between the silicon atoms, there is not only an inorganic network, formed via Si- or metal-oxygen bridges, but also a second, organic network which is reticulated with the first, inorganic network and which significantly augments the stability of the membrane, especially against water.

Useful adhesion promoters include in principle all adhesion promoters which satisfy the abovementioned formula I and where at least two adhesion promoters each have an alkyl radical which is capable of entering into a chemical reaction with the alkyl radical of the other adhesion promoter to form a covalent bond. In principle, all chemical reactions are feasible, but an addition or condensation reaction is preferable. The adhesion promoters may each have two or one alkyl radical (x in formula I being 1 or 2), but at least one OR group (x being 1, 2 or 3). Preferably, the adhesion promoters used in the process according to the present invention which have a reactive group on the alkyl radical have only one alkyl radical (x=1). The at least two adhesion promoters employed in the process of the present invention can be for example an adhesion promoter having an amino group on the alkyl radical and an adhesion promoter having a glycidyl group on the alkyl radical. It is particularly preferable for the process of the present invention to employ 3-aminopropyltriethoxysilane (AMEO) and 3-glycidyloxytrimethoxysilane (GLYMO) as adhesion promoters. Preferably, the molar ratio of the two adhesion promoters to each other is in the range from 100:1 to 1:100 and preferably in the range from 2:1 to 1:2 and most preferably about 1:1. Methacryloyloxypropyltrimethoxysilane (MEMO) is preferably used as a UV-active adhesion promoter which is capable of forming a covalent bond between the adhesion promoter molecules under the action of UV radiation. The adhesion promoters are available from Degussa AG for example.

To obtain a sufficiently stable network, the suspension of the present invention preferably comprises an adhesion promoter fraction in the range from 0.1 to 50 mass % and preferably in the range from 2 to 35 mass %. As well as the “reactive” adhesion promoters mentioned, the suspension may comprise further adhesion promoters selected from the organo-functional silanes. These adhesion promoters can likewise be present in the suspension at a fraction in the range from 0.1 to 30 mass % and preferably at a fraction in the range from 2 to 20 mass %.

Examples of ways in which the suspension can be applied onto and into the non-woven in the process of the present invention include printing on, pressing on, pressing in, rolling on, knife coating on, spread coating on, dipping, spraying or pouring on.

The non-woven used is preferably less than 30 μm, more preferably less than 20 μm and even more preferably from 10 to 20 μm in thickness. It is particularly preferable to use non-wovens as described in the description of the membrane according to the present invention. It may be preferable for the polymeric fibers to be from 0.1 to 10 μm and preferably from 1 to 5 μm in diameter. It is particularly preferable to use a polymeric non-woven which comprises fibers selected from polyacrylonitrile, polyester, polyimide, polyamide, polytetrafluoroethylene and/or polyolefin, for example polyethylene or polypropylene. More particularly, the polymeric non-woven used will comprise fibers selected from polyester, especially polyethylene terephthalate, and/or polyamide, especially nylon 12.

The suspension used for producing the coating comprises at least the abovementioned fraction of at least one oxide of aluminum, of silicon, of titanium and/or of zirconium and at least one sol of the elements Al, Zr, Ti and/or Si and is prepared by suspending at least the particles of the second fraction in at least one of these sols. The suspension may comprise particulate or polymeric sols. Preferably, the suspension comprises a polymeric sol, especially a polymeric sol of a silicon compound.

The sols are obtained by hydrolyzing at least one precursor compound of the elements Zr, Al, Ti and/or Si with water or an acid or a combination thereof. It may similarly be preferable for the compound to be hydrolyzed to be introduced into alcohol or an acid or a combination thereof prior to hydrolysis. Preferably, the compounds to be hydrolyzed are present dissolved in an anhydrous solvent, preferably alcohol, and are hydrolyzed with from 0.1 to 100 times and preferably from 1 to 5 times the molar ratio of water.

The compound to be hydrolyzed is preferably at least one nitrate, one halide (chloride), one carbonate or one alkoxide compound of the elements Zr, Al and/or Si, preferably Si. More preferably, the compounds to be hydrolyzed are alkoxysilanes, especially tetraethoxysilane (TEOS). The hydrolysis is preferably carried out in the presence of liquid water, water vapor, ice or an acid or a combination thereof.

In one embodiment of the process according to the present invention, particulate sols are prepared by hydrolysis of the compounds to be hydrolyzed. These particulate sols are so called because the compounds formed by hydrolysis in the sol are present in particulate form. Particulate sols can be prepared as described above or in WO 99/15262. These sols customarily have a very high water content, which is preferably above 50% by weight. It may be preferable for the compound to be hydrolyzed to be introduced into alcohol or an acid or a combination thereof prior to hydrolysis. The hydrolyzed compound may be peptized by treatment with at least one organic or inorganic acid, preferably with a 10-60% organic or inorganic acid, more preferably with a mineral acid selected from sulphuric acid, hydrochloric acid, perchloric acid, phosphoric acid and nitric acid or a mixture thereof.

In a further embodiment of the process according to the present invention, polymeric sols are prepared by hydrolysis of the compounds to be hydrolyzed. Polymeric sols are so called because the compounds formed by hydrolysis in the sol are present in polymeric form, i.e., in the form of chains crosslinked across a relatively large space. Polymeric sols customarily contain less than 50% by weight and preferably much less than 20% by weight of water and/or aqueous acid. To obtain the preferred fraction of water and/or aqueous acid, the hydrolysis is preferably carried out in such a way that the compound to be hydrolyzed is hydrolyzed with from 0.5 to 10 times the molar ratio and preferably with half the molar ratio of liquid water, water vapor or ice, based on the hydrolysable group of the hydrolysable compound. The amount of water used can be up to 10 times in the case of compounds which are very slow to hydrolyze, such as tetraethoxysilane for example. A hydrolysis with less than the preferred amount of liquid water, water vapor or ice likewise leads to good results, although using more than 50% less than the preferred amount of half the molar ratio is possible but not very sensible, since hydrolysis would no longer be complete and coatings based on such sols would not be very stable using an amount below this value.

To produce these sols having the desired very low fraction of water and/or acid in the sol, it is preferable for the compound to be hydrolyzed to be dissolved in an organic solvent, especially ethanol, isopropanol, butanol, amyl alcohol, hexane, cyclohexane, ethyl acetate or mixtures thereof, before the actual hydrolysis is carried out. A sol thus produced can be used for producing the suspension of the present invention or else as an adhesion promoter in a pretreatment step.

Both particulate sols and polymeric sols are useful as a sol in the process for preparing the suspension. As well as sols obtainable as just described, it is in principle also possible to use commercially available sols, for example silica sols (such as, say, Levasil, Bayer AG). The process of producing membranes which are particularly useful in the process of the present invention by applying a suspension to, and solidifying it on, a carrier is known per se from DE 10142622 and in similar form from WO 99/15262, but not all the parameters and ingredients are applicable to the production of the membrane produced in the process of the present invention. More particularly, the operation described in WO 99/15262 is in that form not fully applicable to polymeric non-woven materials, since the very watery sol systems described therein frequently do not permit complete, in-depth wetting of the customarily hydrophobic polymeric non-wovens, since most polymeric non-wovens are only badly wetted by very watery sol systems, if at all. It has been determined that even the minutest unwetted areas in the non-woven material can lead to membranes and separators being obtained that have defects (such as holes or cracks, for example) and hence are inutile. An improvement is disclosed in DE 10347569, which claims the use of adhesion promoters to improve the adhesion of the sols to the polymeric substrate.

It has been found that a sol system or suspension whose wetting behavior has been adapted to the polymers will completely penetrate the carrier materials and especially the non-woven materials and so provide defect-free coatings. In the process it is therefore preferable to adapt the wetting behavior of the sol or suspension. This is preferably accomplished by producing polymeric sols or suspensions from polymeric sols, these sols comprising one or more alcohols, for example, methanol, ethanol or propanol or mixtures comprising one or more alcohols. But other solvent mixtures are conceivable as well for addition to the sol or suspension in order that the wetting behavior thereof may be adapted to the non-woven used.

It has been determined that the fundamental change to the sol system and to the suspension resulting therefrom leads to a distinct improvement in the adhesion properties of the ceramic components on the and in a polymeric non-woven material. Such good adhesive strengths are normally not obtainable with particulate sol systems. It is therefore preferable for the non-wovens which are used in the invention, which comprise polymeric fibers, to be coated by means of suspensions which are based on polymeric sols.

It is particularly preferable to use suspensions where the mass fraction of the suspended component is from 0.1 to 150 times and more preferably from 0.5 to 20 times the employed fraction from the sol. The suspended component used may be in particular aluminum oxide particles which are available for example from Martinswerke under the designations MZS 3 and MZS1 and from AlCoA under the designation CT3000 SG, CL3000 SG, CT1200 SG, CT800SG and HVA SG.

A preferred embodiment of the process according to the present invention utilizes a suspension which comprises a sol and at least two fractions of oxidic particles selected from the oxides of the elements Al, Zr, Ti and/or Si and at least one first fraction comprises primary particles having an average particle size in the range from 0.2 to 5 μm and comprises from 10 to 50 parts by mass of the suspension and at least one second fraction has an average primary particle size in the range from 10 nm to 199 nm and comprises from 5 to 50 parts by mass of the suspension. The particles of the first fraction are preferably aluminum oxide particles and are available for example from Martinswerke under the designations MZS 3 and MZS1 and from AlCoA under the designation CT3000 SG, CL3000 SG, CT1200 SG, CT800SG and HVA SG. Aluminum oxide, silicon oxide or zirconium oxide particles of the second fraction are obtainable for example from Degussa AG under the designations Sipernat, Aerosil, Aerosil P25 or Zirkoniumoxid VP.

It has been determined that the use of commercially available oxidic particles leads to unsatisfactory results in certain circumstances, since the particle size distribution is frequently very wide. It is therefore preferable to use metal oxide particles which have been classified by a conventional process, for example wind sifting and hydro classification.

To improve the adhesion of the inorganic components to polymeric fibers or non-wovens, but also to improve the adhesion of the shutdown particles to be applied later, it may be preferable for the suspensions used to be admixed with further adhesion promoters, for example organofunctional silanes, for example the Degussa silanes AMEO (3-aminopropyltriethoxysilane), GLYMO (3-glycidyloxytrimethoxysilane), MEMO (3-methacryloyloxypropyltrimethoxysilane), Silfin (vinylsilane+initiator+catalyst), VTEO (vinyltriethoxysilane). The admixing of adhesion promoters is preferable in the case of suspensions based on polymeric sols. Useful adhesion promoters include in general terms especially compounds selected from the octylsilanes, the vinylsilanes, the amine-functionalized silanes and/or the glycidyl-functionalized silanes. Particularly preferred adhesion promoters are amine-functional silanes for polyamides and glycidyl-functionalized silanes for polyesters. Other adhesion promoters can be used as well, but they have to be adapted to the respective polymers. Adhesion promoters have to be chosen such that the solidification temperature is below the melting or softening temperature of the polymer used as a substrate and below the decomposition temperature of the polymer. Preferably, suspensions according to the present invention contain very much less than 25% by weight and preferably less than 10% by weight of compounds capable of acting as adhesion promoters. An optimal fraction of adhesion promoter results from coating the fibers and/or particles with a monomolecular layer of adhesion promoter. The amount in grams of adhesion promoter required for this purpose can be obtained by multiplying the amount (in g) of the oxides or fibers used by the specific surface area of the materials (in m² g⁻¹) and then dividing by the specific area required by the adhesion promoters (in m² ge⁻¹), the specific area required frequently being in the range from 300 to 400 m² g⁻¹ in order of magnitude.

The suspension present on and in the polymeric non-woven as a result of having been applied thereto can be solidified by heating to a temperature in the range from 50 to 350° C. for example. Since, when polymeric materials are used, the maximum allowable temperature is dictated by the softening/melting temperature of this material, the maximum allowable temperature has to be adapted accordingly. Thus, depending on the embodiment of the process, the suspension present on and in the non-woven is solidified by heating at from 100 to 350° C. and most preferably by heating at from 200 to 280° C. It may be preferable for the heating to take place at from 150 to 350° C. for from 1 second to 60 minutes. It is particularly preferable to solidify the suspension by heating at from 110 to 300° C. and most preferably at from 170 to 220° C. and preferably for from 0.5 to 10 min. The solidifying by heating the suspension preferably takes from 0.5 to 10 minutes at from 200 to 220° C. on a polymeric non-woven comprising fibers composed of polyester, especially PET, from 0.5 to 10 minutes at from 130 to 180° C. on a polymeric non-woven comprising fibers composed of polyamide, especially nylon 12, and from 0.5 to 10 minutes at from 100 to 140° C. on a polymeric non-woven comprising fibers composed of polyethylene. The heating of the assembly may be effected by means of heated air, hot air, infrared radiation or by other heating methods according to the background art.

The process for producing the membranes of the present invention can be carried out for example by unrolling the non-woven off a reel, passing it at a speed in the range from 1 m/h to 2 m/s, preferably at a speed in the range from 0.5 m/min to 20 m/min and most preferably at a speed in the range from 1 m/min to 5 m/min through at least one apparatus which applies the suspension onto and into the non-woven, for example a roll, a sprayer or a coating knife, and at least one further apparatus which enables the suspension to be solidified on and in the non-woven by heating, for example an electrically heated furnace, and rolling the membrane thus produced up on a second reel. This makes it possible to produce the membrane in a continuous process.

When the membrane of the present invention is to be used as a separator and when this separator is to have a shutdown function, particles having a defined, desired melting temperature can be applied to and fixed on the porous ceramic layer as shutdown particles.

In one embodiment of the process according to the present invention, it will be advantageous for the porous inorganic layer to be hydrophobicized before the shutdown particles are applied to it. The production of hydrophobic membranes which may serve as a starting material for producing the separators of the present invention is described for example in WO 99/62624. Preferably, the porous inorganic layer is hydrophobicized by treatment with alkyl-, aryl- or fluoroalkylsilanes marketed for example by Degussa under the trade name of Dynasilan. It is possible in this context to employ for example the familiar hydrophobicization methods which are employed inter alia for textiles (D. Knittel; E. Schollmeyer, Melliand Textilber. (1998) 79(5), 362-363), with minimal changes to the recipes, for porous permeable composites produced for example by the process described in PCT/EP98/05939. To this end, a permeable composite material (membrane or separator) is treated with a solution which comprises at least one hydrophobic material. It may be preferable for the solvent in the solution to be water, preferably adjusted to a pH in the range from 1 to 3 with an acid, preferably acetic acid or hydrochloric acid, and/or an alcohol, preferably ethanol. The solvent fraction attributable to acid-treated water or to alcohol may in each case be in the range from 0% to 100% by volume. Preferably, the fraction of the solvent which is attributable to water is in the range from 0% to 60% by volume and the fraction of solvent which is attributable to alcohol is in the range from 40% to 100% by volume. The solvent has introduced into it from 0.1 to 30% by weight and preferably from 1% to 10% by weight of a hydrophobic material to prepare the solution. Useful hydrophobic materials include for example the silanes recited above. Surprisingly, good hydrophobicization is obtained not just with strongly hydrophobic compounds such as for example triethoxy(3,3,4,4,5,5,6,6,7,7,8,8-tridecafluorooctyl)silane, but a treatment with methyl-triethoxysilane or i-butyltriethoxysilane is completely sufficient to obtain the desired effect. The solutions are stirred at room temperature to achieve uniform dissipation of the hydrophobic materials in the solution and are subsequently applied to the porous inorganic layer and dried. The drying can be speeded by a treatment at temperatures in the range from 25 to 100° C.

In a further version of the process according to the present invention, the porous inorganic layer can also be treated with other adhesion promoters before the shutdown particles are applied to it. The treatment with one of the adhesion promoters mentioned can then likewise be effected as described above, i.e., by treating the porous inorganic layer with a polymeric sol which comprises a silane adhesion promoter. More particularly, the treatment can be effected by using adhesion promoters in the production of the separator as described above.

The separator surface may be aftertreated at the end of the process to achieve properties such as for example hydrophobicity. This can be done as described above by an aftertreatment with a sol, but also by a plasma treatment.

The layer of shutdown particles is preferably produced by applying a suspension of shutdown particles in a suspension medium selected from a sol, water or solvent, for example alcohol, hydrocarbons, ethers or ketones or a solvent mixture. The particle size of the shutdown particles present in the suspension is freely choosable in principle. However, it is advantageous for the suspension to contain shutdown particles having an average particle size (D_{w}) which is greater than the average pore size of the pores in the porous inorganic layer (dₛ), since this ensures that the pores in the inorganic layer are not clogged by shutdown particles in the course of the production of the separator according to the present invention. The shutdown particles used preferably have an average particle size (D_{w}) which is greater than the average pore diameter (dₛ) and less than 5 dₛ and more preferably less than 2 dₛ.

The solvent used for the dispersion is preferably water. These aqueous dispersions are adjusted to a polymer or wax content in the range from 1% to 60%, preferably from 5% to 50% and most preferably from 20% to 40% by weight. When water is used as a solvent, it is very simple to obtain in the dispersion the preferred average particle sizes from 1 to 10 μm which are very highly suitable for the separators of the present invention.

Using a non-aqueous solvent for producing the wax or polymer dispersion is a preferable way of obtaining average particle sizes of less than 1 μm in the dispersion. It is similarly possible to use mixtures of non-aqueous solvents with water.

To employ shutdown particles smaller in size than the pores in the porous inorganic layer, the particles must be prevented from penetrating into the pores in the porous inorganic layer. Reasons for using such particles can reside for example in large price differences but also in the availability of such particles. One way of preventing the penetration of shutdown particles into the pores in the porous inorganic layer is to adjust the viscosity of the suspension such that absent external shearing forces no penetration of the suspension into the pores in the inorganic layer takes place. Such a high viscosity for the suspension is obtainable for example by adding auxiliaries which influence the flow behavior, for example silicas (Aerosil, Degussa), to the suspension. When auxiliaries are used, for example Aerosil 200, a fraction from 0.1% to 10% by weight and preferably from 0.5% to 50% by weight of silica, based on the suspension, will frequently be sufficient to achieve a sufficiently high viscosity for the suspension. The fraction of auxiliaries can in each case be determined by simple preliminary tests.

It may be preferable for the shutdown particle suspension used to contain adhesion promoters. Such a suspension with adhesion promoter can be applied directly to a membrane/separator even when the separator was not hydrophobicized beforehand. It will be appreciated that a suspension with adhesion promoter can also be applied to a hydrophobicized membrane or to a membrane which has been produced using an adhesion promoter. Adhesion promoters used in the shutdown particle suspension are preferably silanes having amino, vinyl or methacryloyl side groups. Such silanes are obtainable for example from Degussa as pure products or as aqueous solutions of the hydrolyzed silane under for example the designation Dynasilan 2926, 2907 or 2781. An adhesion promoter fraction of not more than 10% by weight in the suspension has been determined to be sufficient for ensuring sufficient adhesion of the shutdown particles to the porous inorganic coating. Shutdown particle suspensions with adhesion promoter preferably contain from 0.1% to 10% by weight, more preferably from 1% to 7.5% by weight and most preferably from 2.5% to 5% by weight of adhesion promoter, based on the suspension.

Useful shutdown particles include all particles having a defined melting point. The particle material is chosen according to the shutdown temperature desired. Since relatively low shutdown temperatures are desired for most batteries, it is advantageous to use shutdown particles selected from particles of polymers, polymer blends, natural and/or artificial waxes. Particularly preferred shutdown particles are particles of polypropylene wax or particles of polyethylene wax.

The shutdown particle suspension may be applied to the porous inorganic layer by printing on, pressing on, pressing in, rolling on, knife coating on, spread coating on, dipping, spraying or pouring on. The shutdown layer is preferably obtained by drying the applied suspension at a temperature in the range from room temperature to 100° C. and preferably in the range from 40 to 60° C. The drying operation has to be carried out in such a way that the shutdown particles do not melt.

It may be preferable for the particles to be fixed after they have been applied to the porous ceramic coating, by heating one or more times to a temperature above the glass transition temperature, so that the particles are fused on without undergoing a change in their actual shape. This makes it possible to ensure that the shutdown particles adhere particularly firmly to the porous inorganic layer.

The applying of the suspension with subsequent drying and any heating to above the glass transition temperature can be carried out continuously or quasi continuously, equivalently to the production of the separator itself, by the separator again being unwound off a reel, led through a coating, drying and, if appropriate, heating apparatus and then rolled up again.

The membranes according to the present invention and the membranes produced according to the present invention can be used as an electrical separator, in which case the membranes used as a separator must not contain any electrically conducting compounds. The membranes according to the present invention can be used in particular as a separator in batteries, especially as a separator in lithium batteries, preferably lithium high power and high energy batteries. Such lithium batteries may comprise an electrolyte comprising lithium salts having large anions in carbonate solvents. Examples of suitable lithium salts are LiClO₄, LiBF₄, LiAsF₆ or LiPF₆, of which LiPF₆ is particularly preferred. Examples of organic carbonates useful as solvents are ethylene carbonate, propylene carbonate, dimethyl carbonate, ethyl methyl carbonate or diethyl carbonate or mixtures thereof.

The present invention also provides batteries, especially lithium batteries or related nonaqueous battery systems, comprising a membrane according to the present invention or produced according to the present invention. Owing to the good bendability of the membrane according to the present invention, such batteries, especially lithium batteries, can also be wound cells having a winding radius of less than 0.5 mm for the smallest coil. The membrane according to the present invention now makes it possible to use ceramic or semiceramic membranes as separators in very tightly wound cells, such as crashed batteries for example, and thus to be able to utilize the advantages associated with these separators. Crashed batteries are typically wound battery cells which, after fabrication, are brought by the action of large external forces into a certain, usually oval or at least non-round shape.

The present invention likewise provides vehicles comprising a battery comprising the separator of the present invention.

Having generally described this invention, a further understanding can be obtained by reference to certain specific examples which are provided herein for purposes of illustration only, and are not intended to be limiting unless otherwise specified.

### EXAMPLES

### Comparative Example 1

### Production of a Ceramic Membrane according to Background Art

To 130 g of water and 15 g of ethanol were initially added 30 g of a 5% by weight aqueous HNO₃ solution, 10 g of tetraethoxysilane, 10 g of Dynasilan AMEO and 10 g of Dynasilan GLYMO (all silanes: Degussa AG). This sol, which was initially stirred for some hours, then had suspended in it 125 g each of Martoxid MZS-1 alumina and Martoxid MZS-3 alumina (both oxides from Martinswerk). This slip was homogenized with a magnetic stirrer for at least a further 24 h, during which the stirred vessel had to be covered over in order that no solvent loss occurred.

The above slip was then used to coat a 56 cm wide polyamide non-woven (PA-Vlies, Freudenberg) having a thickness of about 100 μm and a basis weight of about 30 g/m in a continuous roll coating process wherein the slip is applied by means of a coating knife to the non-woven moving at a belt speed of about 30 m/h and by passing through an oven having a length of 1 m and a temperature of 150° C.

The end result obtained was a membrane having an average pore size of 450 nm that exhibited a very good adhesion for the ceramic to the non-woven. After 24 h immersion in water (at room temperature), virtually no detachment of the ceramic could be found, detachment was scarcely any greater at elevated temperatures.

Then, adhesive strength within the meaning of DIN 58 196-6 Section 3-6 was determined using Tesa 6051 adhesive fabric strip. A small amount of ceramic was detachable from the substrate with the adhesive fabric strip.

### Example 1

### Production of a Ceramic Membrane according to Invention

To 130 g of water and 15 g of ethanol were initially added 30 g of a 5% by weight aqueous HNO₃ solution, 10 g of tetraethoxysilane, 10 g of Dynasylan AMEO and 10 g of Dynasylan GLYMO (all silanes: Degussa AG). This sol, which was initially stirred for some hours, then had suspended in it 125 g each of Martoxid MZS-1 alumina and Martoxid MZS-3 alumina (both oxides from Martinswerk). This slip was homogenized with a magnetic stirrer for at least 24 h, during which the stirred vessel had to be covered over in order that no solvent loss occurred.

A 55 cm wide polyamide non-woven (PA-Vlies from Freudenberg KG) having a thickness of about 100 μm and a basis weight of about 30 g/m² was used for coating. Prior to coating, the polyamide non-woven was continuously pulled past plasma nozzles at a distance of about 50 mm to the polyamide non-woven. The plasma treatment was carried out using a system, consisting of plasma nozzles and generator, from Plasmatreat GmbH, Bisamweg 10, D-33803 Steinhagen. Oxygen was used as working gas.

This was followed by coating with the above slip, as described in the comparative example, in a continuous roll coating process (belt speed about 30 m/h, T=150° C.).

The end result obtained was a membrane having an average pore size of 450 nm that exhibited a very good adhesion for the ceramic to the non-woven. After 24 h immersion in water (at room temperature), no detachment of the ceramic could be found, no detachment was found at elevated temperatures.

Then, adhesive strength within the meaning of DIN 58 196-6 Section 3-6 was determined using Tesa 6051 adhesive fabric strip. No significant amount of ceramic was detachable from the substrate with the adhesive fabric strip.

German patent application 102007005156.7 filed Jan. 29, 2007, is incorporated herein by reference.

Numerous modifications and variations on the present invention are possible in light of the above teachings. It is therefore to be understood that within the scope of the appended claims, the invention may be practiced otherwise than as specifically described herein.

1. A membrane, comprising:
a polymeric non-woven;
a ceramic coating on and in the non-woven;
wherein said ceramic coating comprises at least one oxide selected from the group consisting of Al₂O₃, TiO₂, ZrO₂, BaTiO₃, SiO₂, and mixtures thereof;
wherein said coating comprises at least two fractions of oxides selected from the group consisting of Al₂O₃, TiO₂, ZrO₂, BaTiO₃, SiO₂, and mixtures thereof;
a first ceramic fraction of said coating having been obtained from a sol;
a second fraction of said coating comprising particles having a number average particle size in the range from 200 nm to 5 μm;
wherein said first fraction is present as a layer on said particles of the second fraction;
said coating comprising from 0.1 to 50 parts by mass of the first fraction;
said coating comprising from 5 to 99 parts by mass of the second fraction; and
a network comprising silicon or zirconium; wherein the silicon in the network bonds via oxygen atoms to the oxides of the ceramic coating, via organic radicals to the surface of the polymeric non-woven and via at least one carbon chain to a further silicon; and
wherein said coating is pinhole free.

2. The membrane of claim 1, wherein the first ceramic fraction comprises particles having an average particle size of less than 20 nm and wherein the first ceramic fraction has been produced via a particulate sol.

3. The membrane of claim 1, wherein the first ceramic fraction comprises particles or an inorganic network of the ceramic material each of which were produced via a polymeric sol.

4. The membrane of claim 1, wherein the first ceramic fraction has a layer thickness of less than 100 nm on the particles of the second fraction.

5. The membrane of claim 1, wherein the second particle fraction comprises particles having a BET surface area of less than 5 m²/g.

6. The membrane of claim 1, wherein the polymeric non-woven comprises polymeric fibers selected from the group consisting of fibers of polyethylene, fibers of polyacrylonitrile, fibers of polypropylene, fibers of polyamide, fibers of polyester and mixtures thereof.

7. The membrane of claim 1, wherein the coating comprises from 10 to 80 parts by mass of the first fraction and from 20 to 90 parts by mass of the second fraction based on the mass of the coating.

8. The membrane of claim 1, wherein one particle fraction comprises particles having an average particle size in the range from 0.2 to 5 μm.

9. The membrane of claim 1, wherein the first fraction comprises particles having an average primary particle size in the range from 30 nm to 60 nm and the coating comprises from 10 to 80 parts by mass of the first fraction and from 20 to 90 parts by mass of the second fraction based on the mass of the ceramic coating.

10. The membrane of claim 1, wherein the particles of the second fraction are aluminum oxide particles and the first ceramic fraction is formed from silicon oxide.

11. The membrane of claim 1, which is bendable down to a radius of 5 mm without defects arising as a result.

12. A process for producing a membrane, comprising:
providing a polymeric non-woven with a ceramic coating in and on the non-woven by applying a suspension onto and into the polymeric non-woven and solidifying said suspension on and in the non-woven by heating one or more times,
wherein said suspension comprises a sol and at least one fraction of oxidic particles selected from the group consisting of oxides of the elements Al, Zr, Ti, Ba, Si and mixtures thereof,
wherein the polymeric non-woven is subjected to a plasma treatment prior to application of the suspension, and
the suspension has added to it prior to application a mixture of at least two different adhesion promoters which are each based on an alkylalkoxysilane of the general formula I
Rₓ—Si(OR)₄₋ₓ (I)
wherein x=1 or 2 and R=organic radical, the R radicals being the same or different,
the adhesion promoters being selected so that the at least two different adhesion promoters comprise alkyl radicals which at least each comprise a reactive group as a substituent,
the reactive group on the alkyl radical of one adhesion promoter reacting with the reactive group of the other adhesion promoter or of the plasma treated polymeric surface during the one or more heating steps to form a covalent bond, or
one or more adhesion promoters as per the formula I, which have reactive groups which are capable of reacting under the action of UV radiation to form a covalent bond,
the addition of an adhesion promoter which reacts under the action of UV radiation being followed by one or more treatments with UV radiation after the suspension has been applied to the polymeric non-woven.

13. The process according to claim 12, wherein a working gas for the plasma treatment comprises nitrogen, oxygen, air, argon, helium, carbon dioxide, carbon monoxide, ozone, silanes, alkanes, fluoroalkanes, fluoroalkenes or mixtures thereof.

14. The process according to claim 12, wherein the plasma treatment is performed using a radio frequency plasma, cyclotron resonance frequency plasma or microwave plasma.

15. The process according to claim 12, wherein the plasma treatment is performed with a plasma having a plasma power in the range from 10 to 1000 W.

16. The process according to claim 12, wherein the plasma treatment is performed using a gap of 0.1 to 300 mm between a nozzle and the polymer non-woven.

17. The process according to claim 12, wherein the plasma treatment is effected at a substrate speed of 60-0.002 m/min.

18. The process according to claim 12, wherein the fibers of the polymeric non-woven are selected from the group consisting of fibers of polyester, fibers of polyethylene, fibers of polypropylene, fibers of polyamide and mixtures thereof.

19. The process according to claim 12, wherein the suspension comprises at least one sol of a compound of the elements Al, Si, Ti, Ba or Zr and wherein the suspension is produced by suspending a fraction of oxidic particles in said at least one sol.

20. The process according to claim 12, wherein the suspension comprises a polymeric sol of a compound of silicon.

21. The process according to claim 12, wherein the sol is obtained by hydrolyzing a precursor compound of the sol of the elements Al, Zr, Ti, Ba or Si with water or an acid or a combination thereof.

22. The process according to claim 12, wherein suspended particle fractions comprise from 1.5 to 150 times by mass of a first fraction of the sol.

23. The process according to claim 12, wherein 3-aminopropyltriethoxysilane (AMEO) and 3-glycidyloxytrimethoxysilane (GLYMO) are used as adhesion promoters capable of forming a covalent bond on heating.

24. The process according to claim 12, wherein methacryloyloxypropyltrimethoxysilane (MEMO) is used as an adhesion promoter capable of forming a covalent bond under the action of UV radiation.

25. The process according to claim 12, wherein a treatment with UV radiation is effected before or after the one or more heating steps.

26. The process according to claim 12, wherein the suspension present on and in the polymeric non-woven is solidified by heating to a temperature in the range from 50 to 350° C.

27. The process according to claim 26, wherein, on the polymeric non-woven comprising polyester fibers, the suspension is heated at a temperature in the range from 200 to 220° C. for from 0.5 to 10 minutes.

28. The process according to claim 26, wherein, on the polymeric non-woven comprising polyamide fibers, the suspension is heated at a temperature in the range from 130 to 180° C. for from 0.5 to 10 minutes.

29. The process according to claim 26, wherein the suspension comprises
from 5 to 50 parts by mass of at least one fraction of oxidic particles having an average primary particle size in the range from 10 nm to 199 nm, based on the weight of the suspension, and
from 30 to 94 parts by mass of at least one fraction comprising primary particles having an average particle size in the range from 200 nm to 5 μm, based on the weight of the suspension.

30. A membrane obtained by the process of claim 12.

31. A filtering membrane or an electrical separator, comprising: the membrane of claim 1, wherein said membrane is free of any titanium compounds when used as a separator.

32. A lithium battery, comprising: the membrane of claim 1 as a separator.

33. A vehicle, comprising: the lithium battery of claim 32.

34. A filtration apparatus, comprising: the membrane of claim 1.
